(19) United States
(12) Patent Application Publication
(10) Pub. No.: US 2021/0029989 A1
(43) Pub. Date: Feb. 4, 2021

(54) AGROCHEMICAL POLYMER DISPERSANTS

(71) Applicant: Croda International Plc, Goole East Yorkshire (GB)

(72) Inventors: Kathryn Marie Knight, Goole East Yorkshire (GB); Simon Adrian Hodgson, Goole East Yorkshire (GB)

(73) Assignee: Croda International Plc, Goole East Yorkshire (GB)

(21) Appl. No.: 17/042,632

(22) PCT Filed: Mar. 28, 2019
(86) PCT No.: PCT/EP2019/057958

§ 371 Date: Sep. 28, 2020

(30) Foreign Application Priority Data
Mar. 28, 2018 (GB) 1805083.1

(51) Int. Cl. A01N 25/10; C08F 220/06; C08F 220/28; C08F 212/08; C08F 220/58

(52) U.S. Cl. CPC A01N 25/10; C08F 220/06; A01N 25/30; C08F 212/08; C08F 220/585; C08F 220/286

(57) ABSTRACT

A copolymer dispersant having acrylic acid, hydrophobic monomer, alkylacrylate of a monoalkyl polyethylene glycol, and optionally strong acid derivatives of (meth)acrylic acid combined with agrochemical active and/or nutrient and/or biostimulant to form a formulation. There is also provided a method of making the polymer dispersant. The dispersant is suitable for use in agrochemical formulations.

The present invention relates to polymer dispersants for agrochemical active formulations, and a method of providing dispersancy in agrochemical formulations comprising said polymer compounds with one or more agrochemical actives. The present invention also includes methods of treating crops with such formulations.

Agrochemical formulations typically include dissolved or dispersed components such as actives and additives or dispersants are often added to formulations to help disperse these components.

Regulations are driving a trend to more water based systems which causes problems for actives which are not very water soluble (hydrophobic sparingly soluble). Additionally often when more active is included in a formulation this can lead to unfavourable crystal growth.

One particular problem with agrochemical formulations is there is an increasing difficulty in dispersing actives, and this is especially since the trend is to use less or sparingly soluble actives. The trend is to use more hydrophilic actives which results in them being harder to disperse. Additionally these actives can increase the possibility of Otswald ripening. Therefore dispersants which can be used with less dispersible actives can be used in a larger range of actives, including those which are very hydrophobic.

Additionally a dispersant is required which provides homogeneity to the agrochemical formulation and helps reduce and/or prevent flocculation and agglomeration.

Whilst conventional dispersants exist, there is a growing trend to use components which are less soluble and therefore more difficult to disperse. There is a need for more effective dispersants able to disperse these less soluble components. In particular dispersants which can be used with a broader range of components or actives are required, and especially those which are hydrophobic. Desirably the dispersant would also be able to prevent or minimize changes to particle size distribution and preferably also help to control crystalline size or morphology.

The present invention seeks to provide compounds suitable for use as dispersants in agrochemical formulations, where said dispersants are able to overcome the above described problems. Additionally, the present invention seeks to provide dispersants which have desired properties such as dispersancy with a wide range of actives. The present invention provides for the use of the dispersant compounds in agrochemical compositions in combination with an agrochemical active and/or nutrients, where the compounds may provide desired dispersancy. The present invention also seeks to provide the use of agrochemical concentrates and dilute formulations comprising said dispersants. The present invention also seeks to provide effective steric and electrostatic stability to a formulation.

According to a first aspect of the present invention there is provided an agrochemical formulation comprising;
i) a copolymer dispersant comprising a polymer of acrylic acid, hydrophobic monomer, alkylacrylate of a monoalkyl polyethylene glycol, and optionally strong acid derivatives of (meth)acrylic acid; and
ii) at least one agrochemical active and/or nutrient and/or biostimulant.

According to a second aspect of the present invention there is provided a concentrate formulation suitable for making an agrochemical formulation of the first aspect, said concentrate comprising;
i) a copolymer dispersant comprising a copolymer of acrylic acid, hydrophobic monomer, alkylacrylate of a monoalkyl polyethylene glycol, and optionally strong acid derivatives of (meth)acrylic acid; and
ii) at least one agrochemical active and/or nutrient and/or biostimulant.

According to a third aspect of the present invention there is provided the use of copolymer acrylic acid, hydrophobic monomer, alkylacrylate of a monoalkyl polyethylene glycol, and optionally strong acid derivatives of (meth)acrylic acid, as dispersant in an agrochemical formulation comprising at least one agrochemical active and/or nutrient and/or biostimulant.

According to a fourth aspect there is provided a method of preparing a copolymer for agrochemical use according to the first aspect, said method comprising mixing and polymerising:
acrylic acid,
hydrophobic monomer,
alkylacrylate of a monoalkyl polyethylene glycol,
and optionally strong acid derivatives of (meth)acrylic acid, to form a random block copolymer.

According to a fifth aspect of the present invention there is provided a method of treating vegetation to control pests, the method comprising applying a formulation of the first aspect, and/or a diluted concentrate formulation of the second aspect, either to said vegetation or to the immediate environment of said vegetation.

According to a sixth aspect of the present invention, there is provided a copolymer comprising a copolymer of acrylic acid, hydrophobic monomer, alkylacrylate of a polyethylene glycol, and optionally strong acid derivatives of (meth)acrylic acid, suitable for use as a dispersant in an agrochemical formulation.

It has been found that polymers formed from acrylic acid, hydrophobic monomer, alkylacrylate of a monoalkyl polyethylene glycol, optionally strong acid derivatives of (meth)acrylic acid provide for desired dispersancy properties when used in an agrochemical formulation having at least one agrochemical active and/or nutrient and/or biostimulant.

As used herein, the terms ‘for example,’ ‘for instance,’ ‘such as,’ or ‘including’ are meant to introduce examples that further clarify more general subject matter. Unless otherwise specified, these examples are provided only as an aid for understanding the applications illustrated in the present disclosure, and are not meant to be limiting in any fashion.

It will be understood that, when describing the number of carbon atoms in a substituent group (e.g. ‘C₁ to C6 alkyl’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branch groups.

The acrylic acid monomer used to form the copolymer may be selected from (meth)acrylic acid or salts thereof, (meth)acrylamide, (meth)acrylonitrile, C1-6-alkyl (meth)acrylates such as ethyl (meth)acrylate, butyl (meth)acrylate or hexyl (meth)acrylate, 2-ethylhexyl (meth)acrylate, substituted C1-6-alkyl (meth)acrylates such as glycidyl methacrylate and acetoacetoxyethyl methacrylate, di(C1-4-alkylamino)C1-6-alkyl (meth)acrylates such as dimethylaminoethyl acrylate or diethylaminoethyl acrylate, amides formed from C1-6-alkylamines, substituted C1-6-alkyl-amines such as 2-amino-2-methyl-1-propane sulphonic acid, ammonium salt, or di(C1-4-alkyl-amino)C1-6-alkylamines and (meth)acrylic acid and C1-4-alkyl halide adducts thereof.

Preferably the acrylic acid monomer may be acrylic acid, methacrylic acid, crotonic acid, or a mixture thereof. More preferably, the monomer is acrylic acid.

The hydrophobic monomer may be selected from any monomer which is water insoluble. In particular, the hydrophobic monomer may be selected from hydrophobic alkyl (meth)acrylates, styrenes, and vinyl compounds, and vinyl aromatic monomers.

In particular vinyl aromatic monomers may be preferred.

The vinyl aromatic monomer(s) can be, and desirably is, styrene as such or a substituted styrene particularly a hydrocarbyl, desirably alkyl, substituted styrene, in which the substituent(s) are on the vinyl group or on the aromatic ring of the styrene e.g. α-methyl styrene and vinyl toluene.

Suitable vinyl aromatic monomers may preferably comprise from 8 to 20 carbon atoms, most preferably from 8 to 14 carbon atoms. Styrenes and substituted styrenes are preferred where the substituent group, if present, is a C1-C6 alkyl groups.

Examples of vinyl aromatic monomers are styrene including substituted styrene, 1-vinyl naphthalene, 2-vinyl naphthalene, 3-methyl styrene, 4-propyl styrene, t-butyl styrene, 4-cyclohexyl styrene, 4-dodecyl styrene, 2-ethyl-4-benzyl styrene, 4-(phenylbutyl) styrene, alphα-methylstyrene, and halogenated styrenes.

The styrene monomer can be or may also comprise styrene monomers including strongly acidic, particularly sulphonic acid, substituents. When present such strong acid modified monomers usually form from 1 to 30 mol. %, more usually 2 to 20 mol. %, and desirably from 5 to 15 mol. %, of the styrene monomers in the copolymer.

Preferably the hydrophobic monomer may be styrene, α-methyl styrene, p-methyl styrene, t-butyl styrene, or a combination thereof. More preferably, the hydrophobic monomer may be styrene.

The alkylacrylate of a monoalkyl polyethylene glycol may preferably be a non-ionic hydrophilic monomer.

The alkyl group either as part of the alkylacrylate or monoalkyl groups, may independently be selected from a C1-C6 alkyl, and in particular a C1-C3 alkyl. The alkyl group may preferably be selected from methyl, ethyl, n-butyl, or t-butyl. Preferably the alkyl group is methyl.

The number-average molecular mass of the monoalkyl polyethylene glycol (i.e. the PEG chain only and not the whole alkylacrylate of a monoalkyl polyethylene glycol) may be at least 300 daltons, preferably ranging from 350 to 900 daltons, more preferably in the range from 400 to 600 daltons.

Some of the monoalkyl polyethylene glycols employed as initial materials in this invention occur in commerce. Thus methyl ethers of total molecular weights of 500 and 550, and designated, respectively, in commerce as methoxy polyethylene glycol 550 and methoxy polyethylene glycol 750, are available on the market.

Preferably, the alkylacrylate of a monoalkyl polyethylene glycol is a methoxy polyethylene glycol methacrylate (MPEGMA), and more particularly a methoxy polyethylene glycol 500 methacrylate.

Strong acid derivatives of (meth)acrylic acid, may include strong acids comprising sulphate acid or sulphonic acid groups (or their salts). Examples of such monomers include sodium methallyl sulphonate, sodium styrene sulphonate, acrylamido methyl propyl sulphonate (AMPS) and (meth)acrylic acid isethionate.

When present such strong acid modified monomers usually form from 1 to 30 mol. %, more usually 2 to 20 mol. %, and desirably from 5 to 15 mol. %, of the acrylic acid monomers in the copolymer.

The polymer may be formed from hydrophobic monomers and may be a water soluble polymer, said solubility arising as a result of neutralisation of the polymer.

It will be understood that the terms “copolymer” as used herein includes polymers with two components as well as ter-polymers and terta polymers, and generally any polymer with two or more components. The copolymer may preferably be a random ter-polymer or tetra polymer, optionally with a strong acid derivatives of (meth)acrylic acid monomer.

The copolymer may be formed by any suitable method, and this may include free radical solution polymerisation or controlled living polymerisation. The monomers may be added concurrently in a controlled manor over a period of time with suitable initiator.

The amount of acrylic acid monomer present in the polymer may be in the range from 10 wt. % to 90 wt. %. Preferably, 15 wt. % to 60 wt. %. More preferably from, 20 wt. % to 50 wt. %. Most preferably, from 30 wt. % to 40 wt. %.

The amount of vinyl aromatic monomer present in the polymer may be in the range from 10 wt. % to 90 wt. %. Preferably, 15 wt. % to 60 wt. %. More preferably from, 15 wt. % to 40 wt. %. Most preferably, from 20 wt. % to 30 wt. %.

The amount of alkylacrylate of a polyethylene glycol monomer present in the polymer may be in the range from 10 wt. % to 90 wt. %. Preferably, 15 wt. % to 60 wt. %. More preferably from, 20 wt. % to 50 wt. %. Most preferably, from 30 wt. % to 40 wt. %.

When present such strong acid modified monomers usually form from 1 to 30 mol. %, more usually 2 to 20 mol. %, and desirably from 5 to 15 mol. %, of the acrylic acid monomers in the copolymer.

Other monomers, such as acidic monomers e.g. itaconic acid or maleic acid or anhydride; strongly acidic monomers such as methallyl sulphonic acid (or a salt); or non-acidic acrylic monomers e.g. acrylic esters which may be alkyl esters particularly C1 to C6 alkyl esters such as methyl methacrylate, butyl methacrylate or butyl acrylate or hydroxy alkyl esters particularly C1 to C6 hydroxyalkyl esters such as hydroxy ethyl methacrylate, or hydroxy propyl methacrylate; or vinyl monomers such as vinyl acetate, can be included. Typically, the proportion of such other monomer(s) will be not more than about 10 mol. %, usually not more than about 7 mol. %, more usually not more than about 5 mol. %, of the total monomers used.

The inclusion of monomers having strongly acidic substituent groups in the polymeric dispersant can provide improved dispersion of the solid granular form of the agrochemical formulations when dispersed in hard water, particularly water having a hardness above 500 ppm e.g. up to 1,000 ppm, up to 2,000 ppm or even up to 5,000 ppm.

The polymer may have a molecular weight less than 500,000 Daltons. Preferably, less than 100,000 Daltons. More preferably, less than 75,000 Daltons. The molecular weight may be in the range from 5000 to 75,000 Daltons. More preferably, in the range from 10,000 to 60,000 Daltons. Further preferably, in the range from 15,000 to 50,000 Daltons. Most preferably, in the range from 20,000 to 40,000 Daltons.

The polymer can be used as the free acid or as a salt. In practice, the form present in a formulation will be determined by the acidity of the formulation. Desirably, the formulation will be near neutral and so most of the acid groups will be present as salts. The cations in any such salt can be alkali metal, particularly sodium and/or potassium, ammonium, or amine, including alkanolamine such as ethanolamine, particularly tri-ethanolamine. In particular, sodium or potassium salts forms of the stabilising polymer are preferred.

The neutralisation with at least 70%, and preferably 75%-85%. Neutralisation with sodium is preferred.

The pH of the polymer may be in the range from 4.0 to 11.0. More preferably, in the range from 5.0 to 10.0. Further preferably, in the range from 5.5 to 9.0. Most preferably, in the range from 6.0 to 8.0.

The emulsion polymer composition may also comprise additional component selected from pigments, dyes, micronutrients, agrochemical actives, bulking agents, and combinations thereof.

Agrochemically active compounds, including insecticides and fungicides, require a formulation which allows the active compounds to be taken up by the plant/the target organisms.

The term ‘agrochemical formulation’ as used herein refers to compositions including an active agrochemical, and is intended to include all forms of compositions, including concentrates and spray formulations. If not specifically stated, the agrochemical formulation of the present invention may be in the form of a concentrate, a diluted concentrate, or a sprayable formulation.

The dispersant of the present invention may be combined with other components in order to form an agrochemical formulation comprising at least one agrochemical active.

Generally the concentrates for which the dispersant is used for are water based suspension concentrates as these are generally used to disperse water insoluble active ingredients where the dispersion is directly in the aqueous phase or absorbed in or adsorbed onto a solid support or as microencapsulated liquid or solutions of actives.

By way of example, the agrochemical active compounds may be formulated as an emulsifiable concentrate (EC), emulsion concentrate (EW), suspension concentrate (SC), and/or suspoemulsions (SE).

In an EC formulation and in an SL formulation, the active compound may be present in dissolved form, whereas in an SC, EW, or SE formulations the active compound may be present as a solid or emulsified liquid.

It is envisaged that the copolymer dispersant of the present invention will particularly find use in a SC, or SE formulation.

Alternatively the copolymer dispersant may be used for formulations comprising actives in the form of water dispersible granules. The granules can include solid support, filler or diluent material(s) which is desirably inert to the agrochemically active material, but which is readily dispersible in water, if necessary in conjunction with dispersing agents. They may also have the benefit of reducing granule dry clumping and the disintegration rate (on addition to water) and can also be used to adjust the active ingredient concentration.

Examples include clays such as kaolin (china clay) and bentonite clays, which may be natural bentonites or modified e.g. activated bentonites, synthetic and diatomaceous silicas, calcium and magnesium silicates, titanium dioxide, aluminium, calcium or magnesium carbonate, ammonium, sodium, potassium, calcium or barium sulphate, charcoal, starch, including modified starches such as alkyl and carboxyalkyl starches, cellulose, such as microcrystalline cellulose, and cellulose derivatives such as carboxyalkyl cellulose, and mixtures of two or more such solid support, filler, diluent materials.

Agrochemical concentrates are agrochemical compositions, which may be aqueous or non-aqueous, and which are designed to be diluted with water (or a water based liquid) to form the corresponding spray formulations. Said compositions include those in liquid form (such as solutions, emulsions, or dispersions) and in solid form (especially in water dispersible solid form) such as granules or powders.

Spray formulations are aqueous agrochemical formulations including all the components which it is desired to apply to the plants or their environment. Spray formulations can be made up by simple dilution of concentrates containing desired components (other than water).

The dispersant may therefore be incorporated into the formulation of the agrochemical active compound (in-can/built-in formulation).

According to the needs of the customer, concentrates thus formed may comprise typically up to 95 wt. % agrochemical actives. Said concentrates may be diluted for use resulting in a dilute composition having an agrochemical active concentration of about 0.5 wt. % to about 1 wt. %. In said dilute composition (for example, a spray formulation, where a spray application rate may be from 10 to 500 1.ha⁻¹) the agrochemical active concentration may be in the range from about 0.001 wt. % to about 1 wt. % of the total formulation as sprayed.

The dispersant of the present invention will typically be used in an amount proportional to the amount of the active agrochemical in the formulation. In agrochemical formulation concentrates, the proportion of the dispersant will depend on the solubility of the components in the liquid carrier. Typically, the concentration of the adjuvant in such a concentrate will be from 1 wt. % to 99 wt. %. Preferably, from 1 wt. % to 70 wt. %. More preferably, from 3 wt. % to 50 wt. %.

Upon dilution to form, for example, a spray formulation, the adjuvant will typically be present at a concentration of from 0.01 wt. % to 2 wt. %, more usually from 0.03 wt. % to 0.5 wt. % of the spray formulation. Further preferably, from 0.12 wt. % to 0.4 wt. % of the spray formulation.

The ratio of dispersant to active agrochemical in the agrochemical formulation is preferably from about 0.05:1 to about 0.5:1. More preferably, from about 0.07:1 to about 0.3:1. Most preferably, from about 0.08:1 to 0.2:1. This ratio range will generally be maintained for concentrate forms of formulations (e.g. where the adjuvant is included in a dispersible liquid concentrate or dispersible solid granule formulation), and in the spray formulations.

When concentrates (solid or liquid) are used as the source of active agrochemical and/or dispersant, the concentrates will typically be diluted to form the spray formulations. The dilution may be with from 1 to 10,000, particularly 10 to 1,000, times the total weight of the concentrate of water to form the spray formulation.

Where the agrochemical active is present in the aqueous end use formulation as solid particles, most usually it will be present as particles mainly of active agrochemical. However, if desired, the active agrochemical can be supported on a solid carrier e.g. silica or diatomaceous earth, which can be solid support, filler or diluent material as mentioned above.

The spray formulations will typically have a pH within the range from moderately acidic (e.g. about 3) to moderately alkaline (e.g. about 10), and particular near neutral (e.g. about 5 to 8). More concentrated formulations will have similar degrees of acidity/alkalinity, but as they may be largely non-aqueous, pH is not necessarily an appropriate measure of this.

A particular problem is the crystal growth e.g. by “Ostwald ripening” of the active ingredient during relatively short time of storage. Crystal growth by “Ostwald ripening” generally occurs when smaller crystals (which have a larger surface area than bigger crystals” dissolve in the aqueous phase and the material is transported through the continuous phase, to nucleation sites of bigger crystals. As a result, the crystals of the active ingredient may aggregate and sediment, the formulation becomes inhomogeneous; during application, filters and nozzles of the spray equipment can block and the biological efficacy may be reduced. These problems may become pronounced when the formulation is stocked at elevated and/or changing temperatures (as described in US 2002/0040044 A1).

In aqueous suspension concentrates, an additional function of the dispersant can be to prevent an excessive increase in crystal size, for active ingredients with propensity for crystal growth through “Ostwald ripening”. The dispersant chemistry described herein is particularly suitable for active ingredients that are solid at 25° C. and have limited solubility preferably the Log solubility (in water) is −1.5 to +5, most preferably −1 to +3. The logP of the pesticide is preferably −1.5 to +6. Most preferably −0.5 to +6. The polymer of the invention consents the preparation of an aqueous agrochemical formulation containing from 50 to 1200 g/L of at least one pesticide.

The agrochemical formulation may include solvents (other than water) such as monopropylene glycol, oils which can be vegetable or mineral oils such as spray oils (oils included in spray formulations as non-surfactant adjuvants), associated with the first and co-adjuvants. Such solvents may be included as a solvent for the adjuvant, and/or as a humectant, e.g. especially propylene glycol. When used such solvents will typically be included in an amount of from 5 wt. % to 500 wt. %, desirably 10 wt. % to 100 wt. %, by weight of the adjuvant. Such combinations can also include salts such as ammonium chloride and/or sodium benzoate, and/or urea especially as gel inhibition aids.

The agrochemical formulation may also include other components as desired. These other components may be selected from those including:
binders, particularly binders which are readily water soluble to give low viscosity solutions at high binder concentrations, such as polyvinylpyrrolidone; polyvinyl alcohol; carboxymethyl cellulose; gum arabic; sugars e.g. sucrose or sorbitol; starch; ethylene-vinyl acetate copolymers, sucrose and alginates,
diluents, absorbents or carriers such as carbon black; talc; diatomaceous earth; kaolin; aluminium, calcium or magnesium stearate; sodium tripolyphosphate; sodium tetraborate; sodium sulphate; sodium, aluminium and mixed sodium-aluminium silicates; and sodium benzoate,
disintegration agents, such as surfactants, materials that swell in water, for example carboxy methylcellulose, collodion, polyvinylpyrrolidone and microcrystalline cellulose swelling agents; salts such as sodium or potassium acetate, sodium carbonate, bicarbonate or sesquicarbonate, ammonium sulphate and dipotassium hydrogen phosphate;
wetting agents such as alcohol ethoxylate and alcohol ethoxylate/propoxylate wetting agents;
dispersants such as sulphonated naphthalene formaldehyde condensates and acrylic copolymers such as the comb copolymer having capped polyethylene glycol side chains on a polyacrylic backbone;
emulsifiers such as alcohol ethoxylates, ABA block copolymers, or castor oil ethoxylates;
antifoam agents, e.g. polysiloxane antifoam agents, typically in amounts of 0.005 wt. % to 10 wt. % of the formulation;
viscosity modifiers such as commercially available water soluble or miscible gums, e.g. xanthan gums, and/or cellulosics, e.g. carboxy-methyl, ethyl or propylcellulose; and/or
preservatives and/or anti-microbials such as organic acids, or their esters or salts such as ascorbic e.g. ascorbyl palmitate, sorbic e.g. potassium sorbate, benzoic e.g. benzoic acid and methyl and propyl 4-hydroxybenzoate, propionic e.g. sodium propionate, phenol e.g. sodium 2-phenylphenate; 1,2-benzisothiazolin-3-one; or formaldehyde as such or as paraformaldehyde; or inorganic materials such as sulphurous acid and its salts, typically in amounts of 0.01 wt. % to 1 wt. % of the formulation.

The agrochemical formulation according to the present invention may also contain components, such as surfactant materials which form part of the emulsifier system. Said surfactants may include surfactant dispersants.

Other adjuvants not within the scope of the present invention, such as surfactant adjuvants, may be included in the compositions and formulations of and used in this invention. Examples include alkylpolysaccharides (more properly called alkyl oligosaccharides); fatty amine ethoxylates e.g. coconut alkyl amine 2EO; and derivatives of alk(en)yl succinic anhydride, in particular those described in PCT applications WO 94/00508 and WO 96/16930.

Suitable agrochemical actives for use in the formulations according to the invention are all agrochemically active compounds that may be solid or liquid at room temperature. It is envisaged that the adjuvant of the present invention would have broad applicability to all types of agrochemical actives.

Agrochemical actives refer to biocides which, in the context of the present invention, are plant protection agents, more particular chemical substances capable of killing different forms of living organisms used in fields such as medicine, agriculture, forestry, and mosquito control. Also counted under the group of biocides are so-called plant growth regulators.

Biocides for use in agrochemical formulations of the present invention are typically divided into two sub-groups:
pesticides, including fungicides, herbicides, insecticides, algicides, moluscicides, miticides and rodenticides, and
antimicrobials, including germicides, antibiotics, antibacterials, antivirals, antifungals, antiprotozoals and antiparasites.

In particular, biocides selected from insecticides, fungicides, or herbicides may be particularly preferred.

The term ‘pesticide’ will be understood to refer to any substance or mixture of substances intended for preventing, destroying, repelling, or mitigating any pest. A pesticide may be a chemical substance or biological agent (such as a virus or bacteria) used against pests including insects, plant pathogens, weeds, mollusks, birds, mammals, fish, nematodes (roundworms) and microbes that compete with humans for food, destroy property, spread disease or are a nuisance. In the following examples, pesticides suitable for the agrochemical compositions according to the present invention are given.

A fungicide is a chemical control of fungi. Fungicides are chemical compounds used to prevent the spread of fungi in gardens and crops. Fungicides are also used to fight fungal infections. Fungicides can either be contact or systemic. A contact fungicide kills fungi when it comes into contact with the fungicide retained on leaf surfaces. A systemic fungicide is absorbed into plant tissues and kills the fungus when it attempts to invade the host.

Examples of fungicides that can be employed in the present disclosure include, but are not limited to: (3-ethoxypropyl)-mercury bromide, 2-methoxyethylmercury chloride, 2-phenylphenol, 8-hydroxyquinoline sulfate, 8-phenylmercurioxyquinoline, acibenzolar, acibenzolar-S-methyl, acypetacs, acypetacs-copper, acypetacs-zinc, aldimorph, allyl alcohol, ametoctradin, amisulbrom, ampropylfos, anilazine, aureofungin, azaconazole, azithiram, azoxystrobin, barium polysulfide, benalaxyl, benalaxyl-M, benodanil, benomyl, benquinox, bentaluron, benthiavalicarb, benthiavalicarb-isopropyl, benzalkomum chloride, benzamacril, benzamacril-isobutyl, benzamorf, benzohydroxamic acid, bethoxazin, binapacryl, biphenyl, bitertanol, bithionol, bixafen, blasticidin-S, Bordeaux mixture, boscalid, bromuconazole, bupirimate, Burgundy mixture, buthiobate, butylamine, calcium polysulfide, captafol, captan, carbamorph, carbendazim, carboxin, carpropamid, carvone, Cheshunt mixture, chinomethionat, chlobenthiazone, chloraniformethan, chloranil, chlorfenazole, chlorodinitronaphthalene, chloroneb, chloropicrin, chlorothalonil, chlorquinox, chlozolinate, climbazole, clotrimazole, copper acetate, copper carbonate, basic, copper hydroxide, copper naphthenate, copper oleate, copper oxychloride, copper silicate, copper sulfate, copper zinc chromate, cresol, cufraneb, cuprobam, cuprous oxide, cyazofamid, cyclafuramid, cycloheximide, cyflufenamid, cymoxanil, cypendazole, cyproconazole, cyprodinil, dazomet, dazomet-sodium, DBCP, debacarb, decafentin, dehydroacetic acid, dichlofluanid, dichlone, dichlorophen, dichlozoline, diclobutrazol, diclocymet, diclomezine, diclomezine-sodium, dicloran, diethofencarb, diethyl pyrocarbonate, difenoconazole, diflumetorim, dimethirimol, dimethomorph, dimoxystrobin, diniconazole, diniconazole-M, dinobuton, dinocap, dinocap-4, dinocap-6, dinocton, dinopenton, dinosulfon, dinoterbon, diphenylamine, dipyrithione, disulfiram, ditalimfos, dithianon, DNOC, DNOC-ammonium, DNOC-potassium, DNOC-sodium, dodemorph, dodemorph acetate, dodemorph benzoate, dodicin, dodicin-sodium, dodine, drazoxolon, edifenphos, epoxiconazole, etaconazole, etem, ethaboxam, ethirimol, ethoxyquin, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, fentin chloride, fentin hydroxide, ferbam, ferimzone, fluazinam, fiudioxonil, flumetover, flumorph, fluopicolide, fluopyram, fluoroimide, fluotrimazole, fluoxastrobin, fluquinconazole, flusilazole, flusulfamide, flutianil, flutolanil, flutriafol, fluxapyroxad, folpet, formaldehyde, fosetyl, fosetyl-aluminium, fuberidazole, furalaxyl, furametpyr, furcarbanil, furconazole, furconazole-cis, furfural, furmecyclox, furophanate, glyodin, griseofulvin, guazatine, halacrinate, hexachlorobenzene, hexachlorobutadiene, hexaconazole, hexylthiofos, hydrargaphen, hymexazol, imazalil, imazalil nitrate, imazalil sulfate, imibenconazole, iminoctadine, iminoctadine triacetate, iminoctadine trialbesilate, iodomethane, ipconazole, iprobenfos, iprodione, iprovalicarb, isoprothiolane, isopyrazam, isotianil, isovaledione, kasugamycin, kresoxim-methyl, mancopper, mancozeb, mandipropamid, maneb, mebenil, mecarbinzid, mepanipyrim, mepronil, meptyldinocap, mercuric chloride, mercuric oxide, mercurous chloride, metalaxyl, metalaxyl-M, metam, metam-ammonium, metam-potassium, metam-sodium, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, myclobutanil, myclozolin, N-(efhylmercury)-p-toluene-sulphonanilide, nabam, natamycin, nitrostyrene, nitrothal-isopropyl, nuarimol, OCH, octhilinone, ofurace, orysastrobin, oxadixyl, oxine-copper, oxpoconazole, oxpoconazole fumarate, oxycarboxin, pefurazoate, penconazole, pencycuron, penflufen, pentachlorophenol, penthiopyrad, phenylmercuriurea, phenylmercury acetate, phenylmercury chloride, phenylmercury derivative of pyrocatechol, phenylmercury nitrate, phenylmercury salicylate, phosdiphen, phthalide, picoxystrobin, piperalin, polycarbamate, polyoxins, polyoxorim, polyoxorim-zinc, potassium azide, potassium polysulfide, potassium thiocyanate, probenazole, prochloraz, procymidone, propamocarb, propamocarb hydrochloride, propiconazole, propineb, proquinazid, prothiocarb, prothiocarb hydrochloride, prothioconazole, pyracarbolid, pyraclostrobin, pyraclostrobin, pyrametostrobin, pyraoxystrobin, pyrazophos, pyribencarb, pyridinitril, pyrifenox, pyrimethanil, pyriofenone, pyroquilon, pyroxychlor, pyroxyfur, quinacetol, quinacetol sulfate, quinazamid, quinconazole, quinoxyfen, quintozene, rabenzazole, salicylanilide, sedaxane, silthiofam, simeconazole, sodium azide, sodium orthophenylphenoxide, sodium pentachlorophenoxide, sodium polysulfide, spiroxamine, streptomycin, sulfur, sultropen, TCMTB, tebuconazole, tebufloquin, tecloftalam, tecnazene, tecoram, tetraconazole, thiabendazole, thiadifluor, thicyofen, thifluzamide, thiochlorfenphim, thiomersal, thiophanate, thiophanate-methyl, thioquinox, thiram, tiadinil, tioxymid, tolclofos-methyl, tolylfluanid, tolylmercury acetate, triadimefon, triadimenol, triamiphos, triarimoi, triazbutil, triazoxide, tributyltin oxide, trichlamide, tricyclazole, tridemorph, trifloxystrobin, triflumizole, triforine, triticonazole, uniconazole, uniconazole-P, validamycin, valifenalate, vinclozolin, zarilamid, zinc naphthenate, zineb, ziram, zoxamide and mixtures thereof.

An herbicide is a pesticide used to kill unwanted plants. Selective herbicides kill specific targets while leaving the desired crop relatively unharmed. Some of these act by interfering with the growth of the weed and are often based on plant hormones. Herbicides used to clear waste ground are non-selective and kill all plant material with which they come into contact. Herbicides are widely used in agriculture and in landscape turf management. They are applied in total vegetation control (TVC) programs for maintenance of highways and railroads. Smaller quantities are used in forestry, pasture systems, and management of areas set aside as wildlife habitat.

Examples of herbicides that can be employed in the present disclosure include, but are not limited to: 4-CPA, 4-CPB, 4-CPP, 2,4-D, 3,4-DA, 2,4-DB, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron, bensulide, bentazone, benzadox, benzfendizone, benzipram, benzobicyclon, benzofenap, benzofiuor, benzoylprop, benzthiazuron, bicyclopyrone, bifenox, bilanafos, bispyribac, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole chiorprocarb, carfentrazone, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop, clofop, clomazone, clomeprop, cloprop, cloproxydim, clopyralid, cloransulam, CMA, copper sulfate, CPMF, CPPC, credazine, cresol, cumyluron, cyanatryn, cyanazine, cycloate, cyclosulfamuron, cycloxydim, cycluron, cyhalofop, cyperquat, cyprazine, cyprazole, cypromid, daimuron, dalapon, dazomet, delachlor, desmedipham, desmetryn, diallate, dicamba, dichlobenil, dichloralurea, dichloiTnate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P, fenoxasulfone, fenteracol, fenthiaprop, fentrazamide, fenuron, ferrous sulfate, flamprop, flamprop-M, flazasulfuron, florasulam, fluazifop, fluazifop-P, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, fluorochloridone, fluoroxypyr, flurtamone, fluthiacet, fomesafen, foramsulfuron, fosamine, furyloxyfen, glufosinate, glufosinate-P, glyphosate, halosafen, halosulfuron, haloxydine, haloxyfop, haloxyfop-P, hexachloroacetone, hexaflurate, hexazinone, imazamethabenz, imazamox, imazapic, imazapyr, imazaquin, imazethapyr, imazosulfuron, indanofan, indazifiam, iodobonil, iodomethane, iodosulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, orthodichlorobenzene, orthosulfamuron, oryzalin, oxadiargyl, oxadiazon, oxapyrazon, oxasulfuron, oxaziclomefone, oxyfluorfen, parafluoron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron, procyazine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, quinonamid, quizalofop, quizalofop-P, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluoron, thenylchlor, thiazafluoron, thiazopyr, thidiazimin, thidiazuron, thiencarbazone-methyl, thifensulfuron, thiobencarb, tiocarbazil, tioclorim, topramezone, tralkoxydim, triallate, triasulfuron, triaziflam, tribenuron, tricamba, triclopyr, tridiphane, trietazine, trifloxysulfuron, trifluralin, triflusulfuron, trifop, trifopsime, trihydroxytriazine, trimeturon, tripropindan, tritac tritosulfuron, vemolate, xylachlor and mixtures thereof. [0020] Safeners mean active ingredients applied with herbicides to protect crops against their injury. Some of the safeners that can be employed in the present disclosure include, but are not limited to: benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, R29148, N-phenylsulfonylbenzoic acid amides and mixtures thereof.

An insecticide is a pesticide used against insects in all developmental forms, and include ovicides and larvicides used against the eggs and larvae of insects. Insecticides are used in agriculture, medicine, industry and the household.

Examples of insecticides that can be employed in the present disclosure include, but are not limited to: 1,2-dichloropropane, abamectin, acephate, acetamiprid, acethion, acetoprole, acrinathrin, acrylonitrile, alanycarb, aldicarb, aldoxycarb, aldrin, allethrin, allosamidin, allyxycarb, alpha-cypermethrin, alpha-ecdysone, alpha-endosulfan, amidithion, aminocarb, amiton, amiton oxalate, amitraz, anabasine, athidathion, azadirachtin, azamethiphos, azinphos-ethyl, azinphos-methyl, azothoate, barium hexafluorosilicate, barthrin, bendiocarb, benfuracarb, bensultap, beta-cyfluthrin, beta-cypermethrin, bifenthrin, bioallethrin, bioethanomethrin, biopermethrin, bistrifluoron, borax, boric acid, bromfenvinfos, bromocyclen, bromo-DDT, bromophos, bromophos-ethyl, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, cartap hydrochloride, chlorantraniliprole, chlorbicyclen, chlordane, chlordecone, chlordimeform, chlordimeform hydrochloride, chlorethoxyfos, chlorfenapyr, chlorfenvinphos, chlorfluazuron, chlormephos, chloroform, chloropicrin, chlorphoxim, chlorprazophos, chlorpyrifos, chlorpyrifos-methyl, chlorthiophos, chiOmafenozide, cinerin I, cinerin II, cinerins, cismethrin, cloethocarb, closantel, clothianidin, copper acetoarsenite, copper arsenate, copper naphthenate, copper oleate, coumaphos, coumithoate, crotamiton, crotoxyphos, crufomate, cryolite, cyanofenphos, cyanophos, cyanthoate, cyantraniliprole, cyclethrin, cycloprothrin, cyfluthrin, cyhalothrin, cypermethrin, cyphenothrin, cyromazine, cythioate, DDT, decarbofuran, deltamethrin, demephion, demephion-O, demephion-S, demeton, demeton-methyl, demeton-O, demeton-O— methyl, demeton-S, demeton-S-methyl, demeton-S-methylsulphon, diafenthiuron, dialifos, diatomaceous earth, diazinon, dicapthon, dichlofenthion, dichlorvos, dicresyl, dicrotophos, dicyclanil, dieldrin, diflubenzuron, dilor, dimefluthrin, dimefox, dimetan, dimethoate, dimethrin, dimethylvinphos, dimetilan, dinex, dinex-diclexine, dinoprop, dinosam, dinotefuran, diofenolan, dioxabenzofos, dioxacarb, dioxathion, disulfoton, dithicrofos, d-limonene, DNOC, DNOC-ammonium, DNOC-potassium, DNOC-sodium, doramectin, ecdysterone, emamectin, emamectin benzoate, EMPC, empenfhrin, endosulfan, endothion, endrin, EPN, epofenonane, eprinomectin, esdepallethrine, esfenvalerate, etaphos, ethiofencarb, ethion, ethiprole, ethoate-methyl, ethoprophos, ethyl formate, ethyl-DDD, ethylene dibromide, ethylene dichloride, ethylene oxide, etofenprox, etrimfos, EXD, famphur, fenamiphos, fenazaflor, fenchlorphos, fenethacarb, fenfluthrin, fenitrothion, fenobucarb, fenoxacrim, fenoxycarb, fenpirithrin, fenpropathrin, fensulfothion, fenthion, fenthion-ethyl, fenvalerate, fipronil, flonicamid, flubendiamide, flucofuron, flucycloxuron, flucythrinate, flufenerim, flufenoxuron, flufenprox, fluvalinate, fonofos, formetanate, formetanate hydrochloride, formothion, fomiparanate, fomiparanate hydrochloride, fosmethilan, fospirate, fosthietan, fufenozide, furathiocarb, furethrin, gamma-cyhalothrin, gamma-HCH, halfenprox, halofenozide, HCH, HEOD, heptachlor, heptenophos, heterophos, hexaflumuron, HHDN, hydramethylnon, hydrogen cyanide, hydroprene, hyquincarb, imidacloprid, imiprothrin, indoxacarb, iodomethane, IPSP, isazofos, isobenzan, isocarbophos, isodrin, isofenphos, isofenphosmethyl, isoprocarb, isoprothiolane, isothioate, isoxathion, ivermectin, jasmolin I, jasmolin II, jodfenphos, juvenile hormone I, juvenile hormone II, juvenile hormone III, kelevan, kinoprene, lambda-cyhalothrin, lead arsenate, lepimectin, leptophos, lindane, lirimfos, lufenuron, lythidathion, malathion, malonoben, mazidox, mecarbam, mecarphon, menazon, meperfluthrin, mephosfolan, mercurous chloride, mesulfenfos, metaflumizone, methacrifos, methamidophos, methidathion, methiocarb, methocrotophos, methomyl, methoprene, methothrin, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, molosultap, monocrotophos, monomehypo, monosultap, morphothion, moxidectin, naftalofos, naled, naphthalene, nicotine, nifluridide, nitenpyram, nithiazine, nitrilacarb, novaluron, noviflumuron, omethoate, oxamyl, oxydemeton-methyl, oxydeprofos, oxydisulfoton, para-dichlorobenzene, parathion, parathion-methyl, penfluoron, pentachlorophenol, permethrin, phenkapton, phenothrin, phenthoate, phorate, phosalone, phosfolan, phosmet, phosnichlor, phosphamidon, phosphine, phoxim, phoxim-methyl, pirimetaphos, pirimicarb, pirimiphos-ethyl, pirimiphos-methyl, potassium arsenite, potassium thiocyanate, pp′-DDT, prallethrin, precocene I, precocene II, precocene III, primidophos, profenofos, profluralin, profluthrin, promacyl, promecarb, propaphos, propetamphos, propoxur, prothidathion, prothiofos, prothoate, protrifenbute, pymetrozine, pyraclofos, pyrafluprole, pyrazophos, pyresmethrin, pyrethrin I, pyrethrin II, pyrethrins, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, rotenone, ryania, sabadilla, schradan, selamectin, silafluofen, silica gel, sodium arsenite, sodium fluoride, sodium hexafluorosilicate, sodium thiocyanate, sophamide, spinetoram, spinosad, spiromesifen, spirotetramat, sulcofuron, sulcofuron-sodium, sulfluramid, sulfotep, sulfoxaflor, sulfuryl fluoride, sulprofos, tau-fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetramethrin, tetramethylfluthrin, theta-cypei-methiin, thiacloprid, thiamethoxam, thicrofos, thiocarboxime, thiocyclam, thiocyclam oxalate, thiodicarb, thiofanox, thiometon, thiosultap, thiosultap-disodium, thiosultap-monosodium, thuringiensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb, zeta-cypermethrin, zolaprofos and mixtures thereof.

Miticides are pesticides that kill mites. Antibiotic miticides, carbamate miticides, formamidine miticides, mite growth regulators, organochlorine, permethrin and organophosphate miticides all belong to this category. Molluscicides are pesticides used to control mollusks, such as moths, slugs and snails. These substances include metaldehyde, methiocarb and aluminium sulphate. A nematicide is a type of chemical pesticide used to kill parasitic nematodes (a phylum of worm).

Plant growth regulators mean active ingredients used to influence the growth characteristics of plants. Examples of plant growth regulators which may be used in the present disclosure include, but are not limited to: 1-naphthaleneacetic acid, 1-naphthaleneacetic acid-salt, 1-napthol, 2,4-dichlorophenoxyacetic acid (2,4-D), 2,4-DB, 2,4-DEP, 2,3,5-triiodobenzoic acid, 2,4,5-trichlorophenoxyacetic acid, 2-naphthoxyacetic acid, 2-naphthoxyacetic acid sodium salt, 3-chloro-4-hydroxyphenylacetic acid, 3-indoleacetic acid, 4-biphenylacetic acid, 4-chlorophenoxyacetic acid (4-CPA), 4-hydroxyphenylacetic acid, 6-benzylaminopurine, Auxindole, a-naphthaleneacetic acid K-salt, β-naphfhoxyacetic acid, p-chlorophenoxyacetic acid, dicamba, dichlorprop, fenoprop, indole-3-acetic acid (IAA), indole-3-acetyl-DL-aspartic acid, indole-3-acetyl-DL-tryptophan, indole-3-acetyl-L-alanine, indole-3-acetyl-L-valine, indole-3-butyric acid (IBA), indole-3-butyric acid K-salt, indole-3-propionic acid; a-naphthaleneacetic acid, methyl indole-3-acetate, naphthaleneacetamide, naphthaleneacetic acid (NAA), phenylacetic acid, picloram, potassium naphthenate, sodium naphthenate, 4-hydroxyphenethyl alcohol, 4-CPPU, 6-benzylaminopurine (BA), 6-(Y,Y-dimethylallylamino)purine (2iP), 2-iP-2HC1, adenine, adenine hemisulfate, benzyladenine, kinetin, meta-topolin, N6-benzoyladenine, N-benzyl-9-(2-tetrahydropyranyl) adenine (BPA), N-(2-chloro-4-pyridyl)-N-phenylurea, gibberellic acid (GA₃), gibberellins, gibberellins A4+A7 (GAₙ), ethylene and abscisic acid.

Safeners mean active ingredients applied with herbicides to protect crops against their injury. Some of the safeners that can be employed in the present disclosure include, but are not limited to: benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, R29148, N-phenylsulfonylbenzoic acid amides and mixtures thereof.

Preferred pesticides are fungicides, insecticides, herbicides and growth regulators. Especially preferred pesticides are fungicides and insecticides. Mixtures of pesticides of two or more of the abovementioned classes may also be used. The skilled worker is familiar with such pesticides, which can be found, for example, in the Pesticide Manual, 16th Ed. (2013), The British Crop Protection Council, London. Specific examples of insecticides are from the classes of neonicitinoids and buprofezin. Specific examples of fungicides are from the class of triazoles, thiophanates, dithiocarbamates and methoxyacrylates. Specific examples of herbicides are from the classes of oxyacetamides and pyridinecarboxamides.

The formulation may comprise at least one nutrient. Nutrients refer to chemical elements and compounds which are desired or necessary to promote or improve plant growth. Nutrients generally are described as macronutrients or micronutrients. Suitable nutrients for use in the concentrates according to the invention are micronutrient compounds, preferably those which are solid at room temperature or are partially soluble.

Micronutrients typically refer to trace metals or trace elements, and are often applied in lower doses. Suitable micronutrients include trace elements selected from zinc, boron, chlorine, copper, iron, molybdenum, and manganese. It is envisaged that the dispersant of the present invention would have broad applicability to all types of micronutrients.

The micronutrients may be in a soluble form or included as insoluble solids, and may in the form of salts or chelates. Preferably, the micronutrient is in the form of a carbonate or oxide.

Preferably, the micronutrient may be selected from zinc, calcium, molybdenum or manganese, or magnesium. Particularly preferred micronutrients for use with the present invention may be selected from zinc oxide, manganese carbonate, manganese oxide, or calcium carbonate.

The amount of micronutrient in the concentrate is typically from 5 wt. % to 40 wt. %, more usually, 10 wt. % to 35 wt. %, particularly 15 wt. % to 30, % by weight based on the total concentrate.

Typically, as mixed into formulations during make up the average particle size of solid agrochemicals is from 50 μm to 100 μm, but formulations are typically wet milled after mixing to reduce the average particle size to from 1 μm to 10 μm, more preferably from 1 μm to 5 μm.

The concentrate of the present invention may also comprise at least one macronutrient. Macronutrients typically refer to those comprising nitrogen, phosphorus, and potassium, and include fertilisers such as ammonium sulphate, and water conditioning agents. Suitable macronutrients include fertilisers and other nitrogen, phosphorus, or sulphur containing compounds, and water conditioning agents.

Suitable fertilisers include inorganic fertilisers that provide nutrients such as nitrogen, phosphorus, potassium or sulphur. Examples of such fertilisers include:
for nitrogen as the nutrient: nitrates and or ammonium salts such as ammonium nitrate, including in combination with urea e.g. as uran type materials, calcium ammonium nitrate, ammonium sulphate nitrate, ammonium phosphates, particularly mono-ammonium phosphate, di-ammonium phosphate and ammonium polyphosphate, ammonium sulphate, and the less commonly used calcium nitrate, sodium nitrate, potassium nitrate and ammonium chloride;
for phosphorus as the nutrient: acidic forms of phosphorus such as phosphoric, pyrophosphoric or polyphosphoric acids, but more usually salt forms such as ammonium phosphates, particularly mono-ammonium phosphate, di-ammonium phosphate, and ammonium polyphosphate, potassium phosphates, particularly potassium dihydrogen phosphate and potassium polyphosphate;
for sulphur as the nutrient: ammonium sulphate and potassium sulphate, e.g. the mixed sulphate with magnesium.

Biostimulants may enhance metabolic or physiological processes such as respiration, photosynthesis, nucleic acid uptake, ion uptake, nutrient delivery, or a combination thereof. Non-limiting examples of biostimulants include seaweed extracts (e.g., ascophyllum nodosum), humic acids (e.g., potassium humate), fulvic acids, myoinositol, glycine, and combinations thereof.

The invention further includes a method of treating plants using formulations including at least one agrochemical and the adjuvant of the first aspect. The agrochemical may be one or more phytoactives, for example growth regulators and/or herbicides, and/or pesticides, for example insecticides, fungicides or acaricides.

Accordingly the invention further includes methods of use including:
a method of killing or inhibiting vegetation by applying to the vegetation, or the immediate environment of the vegetation e.g. the soil around the vegetation, a spray formulation including at least one dispersed phase agrochemical and the adjuvant of the first aspect; and/or
a method of killing or inhibiting pests of plants by applying to the plants or the immediate environment of the plants e.g. the soil around the plants, a spray formulations including at least one dispersed phase agrochemical which is one or more pesticides, for example insecticides, fungicides or acaricides, and the adjuvant of the first aspect.

The adjuvant of the present invention will provide adjuvancy to the agrochemical formulation in which it is comprised.

As used herein, the term ‘dispersant’ or ‘dispersancy’ refers to compounds which when added to an agrochemical formulation will improve the agrochemical's desired effect. The copolymer dispersant may affect the diluent, the mixture, the active, or the target by its improvements of the active's performance.

Preferably, the copolymer dispersant of the present invention may find use as either the sole component or principal dispersancy functioning agent when formulated directly into pesticide concentrates.

The materials of the present invention dilute more readily in agricultural concentrates and develop lower fluid viscosities in aqueous systems, either in the concentrate or upon dilution into water prior to spraying. This behaviour provides improved ease of use in both manufacturing and upon dilution of products containing them, especially in colder waters. Reduction of foam stability is also observed which reduces the need for foam control agents. The copolymer dispersant of the present invention may be added to agrochemical formulations without undesirable thickening or destabilisation.

All of the features described herein may be combined with any of the above aspects, in any combination.

In order that the present invention may be more readily understood, reference will now be made, by way of example, to the following description.

It will be understood that all tests and physical properties listed have been determined at atmospheric pressure and room temperature (i.e. 25° C.), unless otherwise stated herein, or unless otherwise stated in the referenced test methods and procedures.

The following test methods were used to determine performance of the dispersant compositions.
Particle size values—the D(v0.5) and D(v0.9) values were determined by dynamic light scattering analysis using a Malvern Mastersizer 2000 with Hydro 2000SM attachments running on de-ionised water set at 2,500 rpm. The refractive index of the material was set as per the reference values below below with an absorbance of 0.1, 15,000 snaps were taken over 15 seconds to obtain the data. From the particle size values obtained D(v0.5) and D(v0.9) values were readily determined.
   Refractive index reference values for:
   Imidacloprid—1.706 refractive index used
   Buprofezin—1.520 refractive index used
Optical Microscopy—the crystalline morphology of the material was assessed by optical microscopy using an Olympus B51 microscope with 10× magnification (unless otherwise stated) under polarised light. The sample was diluted to a 0.5% w/w solution in de-ionised water, and images of crystalline material taken and processed using Olymus Stream Essentials Software. In some cases, arbitrary line measurements on the resultant image were used to confirm particle size of the crystals.
Stability—the stability of all formulations was assessed after the stated time period at room temperature (RT, 25° C.) and 54° C. In some cases the stability assessment was extended to investigate formulation stability at 0° C. and thermocyling (−10° C. to 40° C., 12 hour cycle). All samples were visually assessed to measure sedimentation/creaming that may have occurred.
Suspensibility—Sample was assessed as per CIPAC MT 161. The method preparing 250 ml of aqueous diluted suspension concentrate mixed with thirty inversions of the measuring cylinder, allowing it to stand for a specified time in the cylinder (30 minutes) under defined conditions, and removing the top nine-tenths. The remaining tenth is then assayed either chemically, gravimetrically or by solvent extraction. The method gives an index of the stability of the homogeneity of the diluted suspension concentrate over time. Complete stability of the homogeneity corresponds to 100%.

### SYNTHESIS EXAMPLE

A 1 L round bottomed flash equipped with agitator, condenser and nitrogen sparge was charged with 280 g of 1,2-propanediol and heated to 90° C. A mixture of 105 g methacrylic acid, 70 g styrene, 85 g methoxypolyethyleneglycolmethacrylate and 8 g 2,2′-azodi(2-methylbutyronitrile) was prepared along with a separate solution of 2-acrylamido-2-methylpropane sulfonic acid (28 g in 80 ml of de-ionised water). The two solutions were added concurrently to the flask via peristaltic pumps over a period of 3.5 hours. On completion of the additions, the reaction was held at 90° C. for 2 hours. The resultant acidic polymer solution was cooled and neutralised with a solution of sodium hydroxide.

A number of copolymers were synthesised in accordance with the above method for further testing. Copolymers made were:
C1—copolymer of acrylic acid/styrene/AMPS/methoxy (polyethylene glycol) methacrylate (MW 500), molecular weight 30,000-50,000 daltons, activity 33%

C2—copolymer of acrylic acid/p-methyl styrene/methoxy (polyethylene glycol) methacrylate (MW 500) molecular weight 30,000-50,000 daltons activity 33%

C3-copolymer of acrylic acid/styrene/methoxy (polyethylene glycol) methacrylate (MW 500), molecular weight 30,000-50,000 daltons, activity 33%

C4—copolymer of acrylic acid/p-methyl styrene/AMPS/methoxy (polyethylene glycol) methacrylate (MW 500) molecular weight 30,000-50,000 daltons activity 33%

Testing with Imidacloprid

The copolymers were used to formulate a 500 g/L Imidacloprid SC as per Table 1 below with low levels of dispersant and wetter. Xanthan gum (typically used for structuring) was omitted.

TABLE 1
500 g/L Imidacloprid formulation

| Component | Function | g/100 ml | % w/w |
|---|---|---|---|
| Imidacloprid (97%) SG 1.54 | Insecticide | 51.55 | 43.66 |
| C1/C2 (33%) | Polymeric dispersant | 1.52 | 1.28 |
| Atlas G5002L | Wetting agent | 0.5 | 0.42 |
| Silcolapse 5.001 | Antifoam | 0.1 | 0.08 |
| Proxel GXL | Biocide | 0.1 | 0.08 |
| Pricerine 9091 | Antifreeze | 5.0 | 4.23 |
| Water | Aqueous phase | 59.31 | 50.23 |

The formulations were then tested over 7 days at room temperature (RT) and 54° C. as outlined in the testing schedule in Table 2 below.

TABLE 2
Testing schedule

| | CIPAC | Initial | | |
|---|---|---|---|---|
| Test | MT N° | tests | Day 1 | Day 7 |
| Particle size distribution | n/a | RT | — | RT, 54° C. |
| (PSD) of formulation | | | | |
| concentrate | | | | |
| Suspensibility | 161 | RT | — | RT, 54° C. |
| pH | 75 | RT | — | RT, 54° C. |
| Crystal growth (10% | n/a | RT | 5° C., 54° C. | 5° C., 54° C. |
| solution) by PSD* | | | | |

*Formulation was stored as a 10% solution in CIPAC standard D water for the duration of the testing period

TABLE 3
Results of imidacloprid formulation testing

| | | C1 | | C2 | |
|---|---|---|---|---|---|
| | | Day 1, | Day 7, | Day 1, | Day 7, |
| Testing | | RT | 54° C. | RT | 54° C. |
| pH | | 7.46 | 7.25 | 7.33 | 7.28 |
| PSD (μm) | D(0.5) | 3.835 | 4.593 | 6.345 | 6.499 |
| | D(0.9) | 7.064 | 8.843 | 15.584 | 15.172 |

| | | | | |
|---|---|---|---|---|
| Suspensibilty | 100.5 | 98.7 | N/A | N/A |
| (MT 161) | | | | |

TABLE 4
Results of crystal growth study as 10% diluted
imidacloprid formulation

| | | C1 | | C2 | |
|---|---|---|---|---|---|
| | | Day 1, | Day 7, | Day 1, | Day 7, |
| Testing | | 5° C. | 54° C. | 5° C. | 54 ° C. |
| Crystal | D(0.5) | 3.831 | 3.295 | 6.399 | 6.126 |
| growth by | | | | | |
| PSD (μm) | D(0.9) | 7.496 | 7.769 | 16.339 | 15.432 |

The inclusion of the copolymer (C1 or C2) into the imidacloprid suspension concentrate of Table 1 did not show any increase in particle size distribution when stored as a concentrate or as a 10% dilution for 7 days at 54° C., thus demonstrating the ability to control Ostwald ripening when the copolymers are present at low inclusion levels.

Testing with Buprofezin

The copolymers were further assessed in formulations with 500 g/L Buprofezin SC as per Table 4 below. Xanthan gum (typically used for structuring) was omitted.

TABLE 4
500 g/L Buprofezin formulation recipe

| Component | Function | g/100 ml | % w/w |
|---|---|---|---|
| Buprofezin (98%) SG 1.18 | Insecticide | 51.02 | 47.34 |
| C1/C3/C4 (33 %) | Polymeric dispersant | 3.03 | 2.81 |
| Atlas G5002L | Wetting agent | 1.0 | 0.93 |
| Silcolapse 5.001 | Antifoam | 0.1 | 0.09 |
| Proxel GXL | Biocide | 0.1 | 0.09 |
| Pricerine 9091 | Antifreeze | 5.0 | 4.64 |
| Water | Aqueous phase | 47.53 | 44.10 |

The formulations were then tested over 7 days at room temperature (RT) and 54° C. as per the testing schedule outlined in Table 2 above.

TABLE 5
Results of Buprofezin formulation testing

| | | C1 | | C3 | | C4 | |
|---|---|---|---|---|---|---|---|
| | | Day 1, | Day 7, | Day 1, | Day 7, | Day 1, | Day 7, |
| Testing | | RT | 54° C. | RT | 54° C. | RT | 54° C. |
| pH | | 7.82 | 7.76 | 7.67 | 7.71 | 7.23 | 7.24 |
| PSD | D (0.5) | 3.763 | 4.835 | 3.885 | 5.118 | 3.687 | 4.727 |
| (μm) | D (0.9) | 7.262 | 8.846 | 12.269 | 11.458 | 6.693 | 8.171 |

| | | | | | | |
|---|---|---|---|---|---|---|
| Suspensibilty | 98 | 98 | 89 | 96 | N/A | N/A |
| (MT 161) | | | | | | |

TABLE 6
Results of crystal growth study as
10% diluted buprofezin formulation

| | | C1 | | C3 | | C4 | |
|---|---|---|---|---|---|---|---|
| | | Day 1, | Day 7, | Day 1, | Day 7, | Day 1, | Day 7, |
| Testing | | 5° C. | 54° C. | 5° C. | 54° C. | 5° C. | 54° C. |
| Crystal | D (0.5) | 3.673 | 3.898 | 3.724 | 3.672 | 3.481 | 3.774 |
| growth | D (0.9) | 6.454 | 7.109 | 8.456 | 8.234 | 6.111 | 6.605 |
| by PSD | | | | | | | |
| (μm) | | | | | | | |

The inclusion of the copolymer (C1/C3/C4) into the buprofezin suspension concentrate of Table 2 did not show any increase in particle size distribution when stored as a concentrate or as a 10% dilution for 7 days at 54° C., thus demonstrating the ability to control Ostwald ripening of the pesticide.

It is to be understood that the invention is not to be limited to the details of the above embodiments, which are described by way of example only. Many variations are possible.

1. An agrochemical formulation comprising;
i) a copolymer dispersant comprising a polymer of acrylic acid, hydrophobic monomer, alkylacrylate of a monoalkyl polyethylene glycol, and optionally strong acid derivatives of (meth)acrylic acid; and
ii) at least one agrochemical active and/or nutrient and/or biostimulant.

2. The formulation of claim 1, wherein the acrylic acid monomer used to form the copolymer is selected from (meth)acrylic acid or salts thereof, (meth)acrylamide, (meth)acrylonitrile, C1-6-alkyl (meth)acrylates, substituted C1-6-alkyl (meth)acrylates, di(C1-4-alkylamino) C1-6-alkyl (meth) acrylates, amides formed from C1-6-alkylamines, substituted C1-6-alkyl-amines, or di(C1-4-alkyl-amino)C1-6-alkylamines, and (meth)acrylic acid and C1-4-alkyl halide adducts thereof.

3. The formulation of claim 1, wherein the hydrophobic monomer is selected from hydrophobic alkyl (meth)acrylates, styrenes, and vinyl compounds, and vinyl aromatic monomers.

4. The formulation of claim 1, wherein the alkylacrylate of a monoalkyl polyethylene glycol is a methoxy polyethylene glycol methacrylate (MPEGMA).

5. The formulation of claim 1, wherein the Strong acid derivatives of (meth)acrylic acid are selected from sodium methallyl sulphonate, sodium styrene sulphonate, acrylamido methyl propyl sulphonate (AMPS) and (meth)acrylic acid isethionate.

6. The formulation of claim 1, wherein the copolymer molecular weight is in the range from 5,000 to 75,000 Daltons.

7. A concentrate formulation for making an agrochemical formulation of claim 1, said concentrate comprising;
i) a copolymer dispersant comprising a copolymer of acrylic acid, hydrophobic monomer, alkylacrylate of a monoalkyl polyethylene glycol, and optionally strong acid derivatives of (meth)acrylic acid; and
ii) at least one agrochemical active and/or nutrient and/or biostimulant.

8. Use of copolymer comprising acrylic acid, hydrophobic monomer, alkylacrylate of a monoalkyl polyethylene glycol, and optionally strong acid derivatives of (meth)acrylic acid, as dispersant in an agrochemical formulation comprising at least one agrochemical active and/or nutrient and/or biostimulant.

9. A method of preparing a copolymer for agrochemical use, said method comprising mixing and polymerising:
acrylic acid,
hydrophobic monomer,
alkylacrylate of a monoalkyl polyethylene glycol,
and optionally strong acid derivatives of (meth)acrylic acid, to form a random block copolymer.

10. A method of treating vegetation to control pests, the method comprising applying a formulation of claim 1, either to said vegetation or to the immediate environment of said vegetation.

11. A copolymer comprising a copolymer of acrylic acid, hydrophobic monomer, alkylacrylate of a polyethylene glycol, and optionally strong acid derivatives of (meth)acrylic acid, suitable for use as a dispersant in an agrochemical formulation.
